(19) United States
(12) Patent Application Publication
(10) Pub. No.: US 2015/0007069 A1
(43) Pub. Date: Jan. 1, 2015

(54) ELECTRONIC DEVICE CAPABLE OF RECONFIGURING DISPLAYED ICONS AND METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventor: REN-WEN HUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/256,171

(22) Filed: Apr. 18, 2014

(30) Foreign Application Priority Data
Jun. 26, 2013 (CN) 2013102591073

(51) Int. Cl. G06F 3/0481; G06F 3/0488; G06F 3/0484

(52) U.S. Cl. CPC G06F 3/04817; G06F 3/0484; G06F 3/04847; G06F 3/0488
USPC 715/763

(57) ABSTRACT

A touch method is provided for reconfiguring icons displayed on an electronic device including a touch screen. The method includes determining which hand the user is using to operate the electronic device if the user operates the electronic device in a one-handed manner. Determining which icons displayed on the touch screen are preferred by the user. Moving the determined icons to a first area of the touch screen if the user operates the electronic device using a left hand. Moving the determined icons to a second area of the touch screen if the user operates the electronic device using a right hand.

### FIELD

The present disclosure relates to electronic devices, and particularly to an electronic device which can reconfigure displayed icons in response to operations of a user, and a method for reconfiguring the icons.

### BACKGROUND

Many electronic devices, such as mobile phones, tablet computers, and multimedia players, employ touch screens as input interfaces. Typically, a user holds the electronic device with one hand and uses a finger of the other hand to operate the icons displayed on the screen. In other cases, the user may try to operate the electronic device in a different manner, such as a one-handed operation manner by using the thumb of the holding hand to operate the icons. In such one-handed operation manner, it may be difficult or impossible to operate the all of icons easily, especially when the electronic device has a screen size greater than 4.5 inches.

### BRIEF DESCRIPTION OF THE DRAWINGS

Implementations of the present disclosure will now should be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views. The description is not to be considered as limiting the embodiments described herein.

FIG. 1 is a block diagram of an example electronic device capable of reconfiguring displayed icons.

FIG. 2 is perspective view showing an example first area and an example second area of a touch screen of the electronic device of FIG. 1.

FIG. 3 is a perspective view showing example icons displayed on the touch screen of the eletronic device of FIG. 1.

FIG. 4 is a flowchart of an example method for reconfiguring icons.

### DETAILED DESCRIPTION

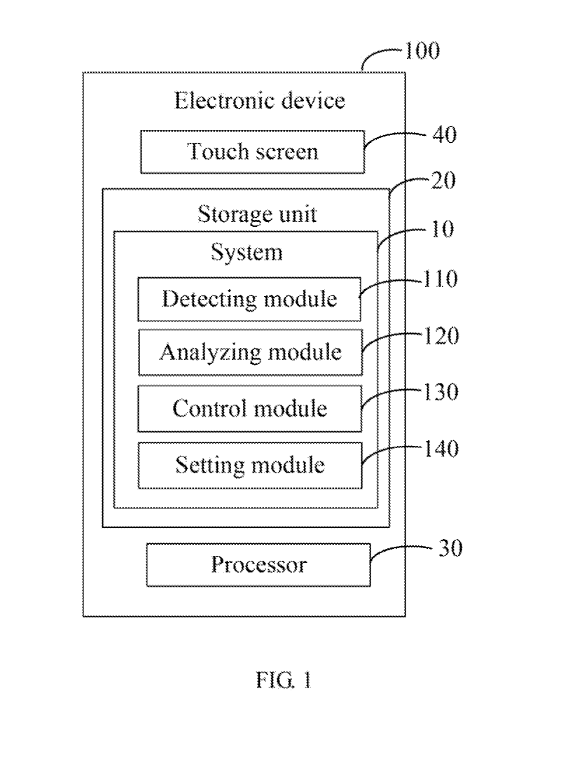

FIG. 1 is a block diagram of an electronic device 100 capable of configuring displayed icons. The electronic device 100, such as a mobile phone or a tablet computer, can include a storage unit 20, a processor 30, and a touch screen 40. The storage unit 20 can store a system 10. The system 10 can include a variety of modules which are a collection of software instructions and executed by the processor 30 to provide the functions of the system 10. In this embodiment, the system 10 is executable by the processor 30 to determine which hand a user is using to operate the electronic device 100. If the user operates the electronic device 100 in a one-handed manner, icons displayed on the touch screen 40 can be then reconfigured according to the hand that the user is using to operate the electronic device 100, thus making the reconfigured icons more suitable for the one-handed manner. The one-handed manner comprises a user holds the electronic device 100 with one hand and operating the electronic device 100 with a finger (usually the thumb) of the holding hand.

In the example illustrated in FIG. 1, the system 10 can include a detecting module 110, an analyzing module 120, and a control module 130.

The detecting module 110 determines which hand the user is using to operate the electronic device 100 when the user operates the electronic device 100 in one-handed manner. In an embodiment, the detecting module 110 determines the location of the touch points at the touch screen 40 according to touch signals from the touch screen 40. If the touch points are located at the left portion of the touch screen 40, the detecting module 110 determines that the user operates the electronic device 100 using the left hand. If the detected touch points are located at the right portion of the touch screen 40, the detecting module 110 determines that the user operates the electronic device 100 using the right hand.

In an alternative embodiment, the detecting module 110 further detects whether a slide operation is performed on the touch screen 40 according to touch signals received from the touch screen 40. The detecting module 110 further determines which hand the user is using to operate the electronic device 100 according to a moving track of the slide operation. If the slide operation is across the upper left corner and the lower right corner of the touch screen 40, the detecting module 110 determines that the user operates the electronic device 100 using the left hand. If the slide operation is across the upper right corner and the lower left corner of the touch screen 40, the detecting module 110 determines that the user operates the electronic device 100 using the right hand.

The analyzing module 120 determines which icons displayed on the touch screen 40 are preferred by the user. In an embodiment, the analyzing module 120 records the number of times each icon is operated by the user within a preset time period, for example, one hour before the analyzing module 120 determines which icons displayed on the screen 40 are preferred by the user, and compares the recorded number of times with a preset number. The preset number is preset by the user. If the recorded number of times is greater than the preset number, the analyzing module 120 determines that the icon is preferred by the user.

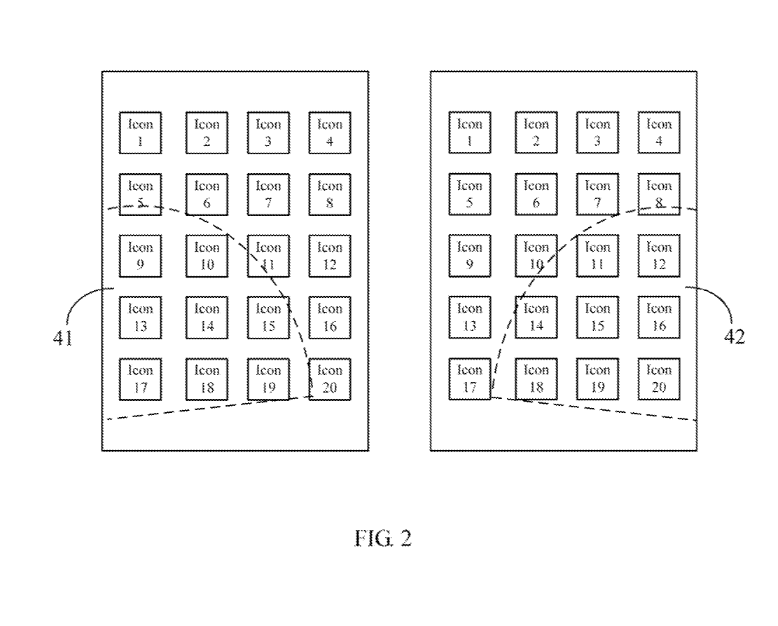

FIG. 2 shows that the control module 130 moves the determined icons to a first area 41 of the touch screen 40 if the user operates the electronic device 100 using the left hand. The determined icons are moved to a second area 42 of the touch screen 40 if the user operates the electronic device 100 using the right hand. In the embodiment, the first area 41 is the lower left corner of the touch screen 40 where the thumb of the left hand can easily reach. The second area 42 is the lower right corner of the touch screen 40 where the thumb of the right hand can easily reach.

In an embodiment, the control module 130 moves the determined icons to the first area 41 or the second area 42, and further moves the icons previously located at the first area 41 or the second area 42 that are not preferred by the user to the original positions of the determined icons. For example, the positions of the determined icons and the positions of the icons located at the first area 41 or the second area 42 that are not preferred by the user are exchanged.

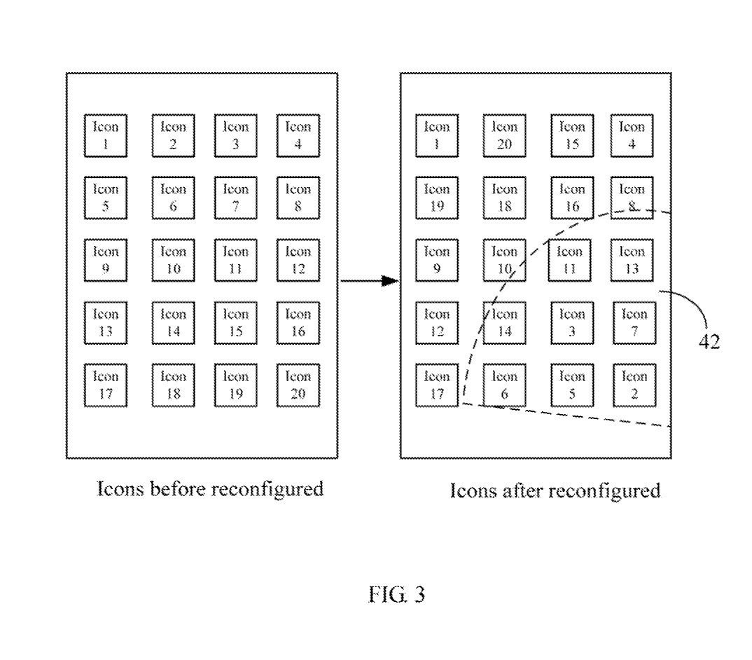

FIG. 3 shows that when determining that the user operates the electronic device 100 using the right hand, the icons 2, 3, 5, 7 which are determined to be preferred by the user are moved to the second area 42, and the icons 12, 15, 16, 18 previously located at the second area 42 are moved to the original positions of the icons 2, 3, 5, 7.

In an embodiment, the system 10 can further include a setting module 140. The setting module 140 provides a user interface on the touch screen 40 for a user to input parameters including the preset number, the preset time period, the size of the first area, and the size of the second area. The storage unit 20 can store the input parameters.

In an embodiment, the user can press a mechanical button of the electronic device 100 to control the system 10 to execute the function of reconfiguring the icons. The electronic device 100 can then enter the one-handed manner. The user can press the button again to control the system 10 to stop executing the function of reconfiguring the icons, and the icons are then returned to the original position and do not move no matter if the user is using the right hand or the left hand to operate the electronic device 100.

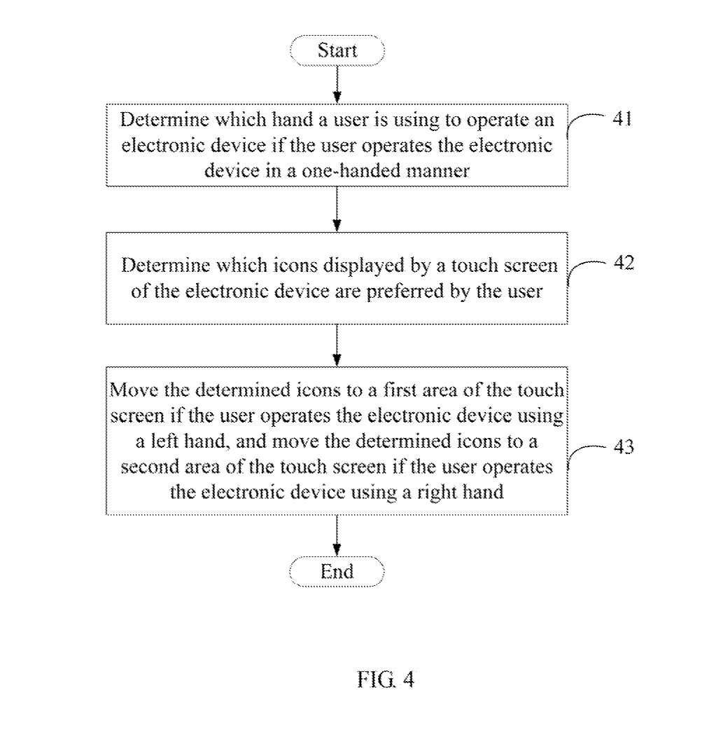

FIG. 4 is a flowchart of a method for reconfiguring icons displayed on the electronic device 100, in accordance with an exemplary embodiment.

In block 41, the detecting module 110 determines which hand the user is using to operate the electronic device 100 if the user operates the electronic device 100 in a one-handed manner. In an embodiment, the detecting module 110 determines the location of the touch points at the touch screen 40 according to touch signals from the touch screen 40. If the touch points are located at the left portion of the touch screen 40, the detecting module 110 determines that the user operates the electronic device 100 using the left hand. If the detected touch points are located at the right portion of the touch screen 40, the detecting module 110 determines that the user operates the electronic device 100 using the right hand.

In block 42, the analyzing module 120 determines which icons displayed on the touch screen 40 are preferred by the user. In an embodiment, the analyzing module 120 records the number of times each icon is operated by the user within a preset time period, and compares the recorded number of times with a preset number. If the recorded number of times is greater than the preset number, the analyzing module 120 determines that the icon is preferred by the user.

In block 43, the control module 130 moves the determined icons to a first area 41 of the touch screen 40 if the user operates the electronic device 100 using the left hand, and moves the determined icons to a second area 42 of the touch screen 40 if the user operates the electronic device 100 using the right hand. In an embodiment, the control module 130 moves the determined icons to the first area 41 or the second area 42, and further moves the icons previously located at the first area 41 or the second area 42 that are not preferred by the user to the original positions of the determined icons.

It is believed that the present embodiments and their advantages will be understood from the foregoing description, and it will be apparent that various changes may be made thereto without departing from the scope of the disclosure or sacrificing all of its material advantages, the examples hereinbefore described merely being exemplary embodiments of the present disclosure.

What is claimed is:

1. An electronic device comprising:
a touch screen; and
a processor configured to execute a plurality of modules,
wherein the plurality of modules comprises:
a detecting module configured to determine which hand the user is using to operate the electronic device, if the user operates the electronic device in a one-handed manner;
an analyzing module configured to determine which icons displayed on the touch screen are preferred by the user; and
a control module configured to move the determined icons to a first area of the touch screen if the user operates the electronic device using a left hand, and move the determined icons to a second area of the touch screen if the user operates the electronic device using a right hand.

2. The electronic device of claim 1, wherein the detecting module is configured to detect touch points on the touch screen according to touch signals received from the touch screen, and determine that the user operates the electronic device using the left hand or the right hand according to locations of the touch points at the touch screen.

3. The electronic device of claim 1, wherein the detecting module is configured to detect whether a slide operation is performed on the touch screen, and determine which hand the user is using to operate the electronic device according to a moving track of the slide operation.

4. The electronic device of claim 3, wherein the detecting module is configured to determine that the user operates the electronic device using the left hand if the slide operation is across the upper left corner and the lower right corner of the touch screen, and determine that the user operates the electronic device using the right hand if the slide operation is across the upper right corner and the lower left corner of the touch screen.

5. The electronic device of claim 1, wherein the analyzing module is configured to record the number of times each icon is operated by the user within a preset time period, compare the recorded number of times with a preset number, and determine that the icon is preferred by the user if the recorded number of times is greater than the preset number.

6. The electronic device of claim 1, wherein the first area is a lower left corner of the touch screen, and the second area is a lower right corner of the touch screen.

7. The electronic device of claim 1, wherein the control module is configured to move the determined icons to the first area or the second area, and move the icons previously located at the first area or the second area to original positions of the determined icons.

8. The electronic device of claim 5, wherein the plurality of modules further comprises a setting module, the setting module is configured to provide a user interface on the touch screen for the user to input parameters comprising the preset number and the preset time period.

9. A method for reconfiguring icons displayed on an electronic device, the electronic device comprising a touch screen, the method comprising:
determining which hand the user is using to operate the electronic device, if the user operates the electronic device in a one-handed manner;
determining which icons displayed on the touch screen are preferred by the user;
moving the determined icons to a first area of the touch screen if the user operates the electronic device using a left hand; and
moving the determined icons to a second area of the touch screen if the user operates the electronic device using a right hand.

10. The method of claim 9, wherein the step of determining which hand the user is using to operate the electronic device comprises:
detecting touch points on the touch screen according to touch signals received from the touch screen; and
determining that the user operates the electronic device using the left hand or the right hand according to locations of the touch points at the touch screen.

11. The method of claim 9, wherein the step of determining which hand the user is using to operate the electronic device comprises:
detecting whether a slide operation is performed on the touch screen; and
determining which hand the user is using to operate the electronic device according to a moving track of the slide operation.

12. The method of claim 11, wherein the step of determining which hand the user is using to operate the electronic device according to a moving track of the slide operation comprises:
determining that the user operates the electronic device using the left hand if the slide operation is across the upper left corner and the lower right corner of the touch screen; and
determining that the user operates the electronic device using the right hand if the slide operation is across the upper right corner and the lower left corner of the touch screen.

13. The method of claim 9, wherein the step of determining which icons displayed on the touch screen are preferred by the user comprises:
recording the number of times each icon is operated by the user within a preset time period;
comparing the recorded number of times with a preset number; and
determining that the icon is preferred by the user if the recorded number of times is greater than the preset number.

14. The method of claim 9, wherein the first area is a lower left corner of the touch screen, and the second area is a lower right corner of the touch screen.
